(19) United States
(12) Patent Application Publication
(10) Pub. No.: US 2008/0208553 A1
(43) Pub. Date: Aug. 28, 2008

(54) Parallel circuit simulation techniques

(75) Inventors: Manjit Borah, Los Altos, CA (US); Khosro Rouz, Saratoga, CA (US)

Correspondence Address: Manjit Borah, 2349 Bering Drive, San Jose, CA, 95131, US

(73) Assignee: Fastrack Design, Inc., San Jose, CA (US)

(21) Appl. No.: 11/712,313

(22) Filed: Feb. 27, 2007

(51) Int. Cl. G06F 17/50

(52) U.S. Cl. 703/14

(57) ABSTRACT

Methods for improving the accuracy and performance of large complex circuit simulations including; special processing of clock structures, minimizing repetitive simulation of identical structures, partitioning designs into sub-systems for use by one of a variety of matrix inversion techniques, row partitioning matrices for parallel solving, applying two stage Newton-Ralphon's method and iteratively selecting one of a number of serial and parallel matrix solvers to perform circuit simulation.

### FIELD OF THE INVENTION

The present invention is related to semiconductor transistor level simulation techniques, particularly improvements to reduce the simulation computation time by parallel processing and utilizing numerical techniques with improved convergence.

### BACKGROUND AND SUMMARY OF THE INVENTION

With the ever shrinking feature sizes and growing demand for high performance and low power from electronic circuits, accurate simulation of large systems of circuits is necessary. SPICE has long been considered the gold standard for circuit simulation accuracy, but the biggest drawback of traditional SPICE tools is their limited capacity and prohibitively long simulation time for most practical circuits. The SPICE transient simulation algorithm involves repeatedly solving a linear form of a modified nodal equation matrix for the circuit in such a way that the circuit node voltages converge to a steady state value at each time step in the simulation. The performance limitation of SPICE is directly related to its method for solving these nodal equation matrices. This has led to improvements in circuit simulation beyond the traditional SPICE modeling.

Feldman et. al. describes the use of symmetric positive definite (SPD) matrix manipulations to generate transfer functions for systems of passive L, R and C elements in U.S. Pat. No. 6,041,170 granted Mar. 21, 2000, and further describes LU factorization applied to SPD matrices as a way to solve non-linear analysis of circuit systems in U.S. Pat. No. 6,182,270, granted Jan. 30, 2001. Still further improvements may be made by doing decomposition of the SPD matrices and performing the LU factorization processing in parallel across multiple processors as described by Nakanishi in U.S. Pat. No. 6,907,513, granted Jun. 14, 2005, but while Nakanishi does not describe the use of these techniques to circuit simulation, Hachiya does in combination with the Newton iteration method in U.S. Pat. No. 6,144,932, granted Nov. 7, 2000. In addition to parallel processing of LU factorization, Hachiya further describes clustering the devices into sub-circuits, balanced to minimize the parallel processing of all sub-circuits.

While the above techniques improve the processing time of circuit simulation, accuracy is also important. For example, the clocks within most ICs are the most timing critical portion of the design, and therefore require special processing, as pointed out by Burks et. al. in U.S. Pat. No. 6,014,510 granted Jan. 1, 2000 and Srinivansan et al. in U.S. Pat. No. 6,851,095 granted Feb. 1, 2005, but unlike Kanamoto et al. in U.S. Pat. No. 6,442,740, they limit their discussion to non-circuit simulation of clock structures. Kanamoto et al. also describes the need to map the passive elements of the power and ground structure, to reduce the computational complexity of the clock structures during circuit simulation.

This disclosure builds on the cited prior art to further improve the execution time of circuit simulation of large systems of transistors and passive components, while maintaining waveform accuracy through a series of techniques. For example, in addition to extracting the clock structure for more exact timing analysis, its typical tree like structure lends itself to partitioning for parallel processing. Similarly, most IC designs are made up of numerous instances of cells and macros, many of which are identically structured, which may be hierarchically preprocessed to reduce the simulation time. Also, because LU decomposition and iterative methods are guaranteed to converge SPD matrices, this disclosure presents a technique for partitioning the system into sub-systems with SPD matrices and well behaved non-SPD matrices, as opposed to min-cuts or structural clustering as described in the prior art.

Furthermore, recognizing that matrix solvers such as LU decomposition, Cholesky's method, Algebraic Multi-Grid (AMG), and Generalized Minimal Residual method (GmRes), each have their own strengths and weaknesses, this disclosure presents techniques for selecting between parallel and serial versions of multiple solvers within a two-stage Newton-Ralphson's iteration method to maximize simulation performance by minimizing non-convergence conditions, while bounding the numerical errors.

### BRIEF DESCRIPTION OF THE DRAWINGS

Embodiments of the invention will now be described in conjunction with the drawings, in which:

FIG. 1 is a diagram of a system of multiple processors with master and slave processors,

FIG. 2 is a diagram of a partitioned clock tree structure,

FIGS. 3a, 3b and 3c are diagrams of a circuit being partitioned into sub-circuits,

FIG. 4 is a flowchart of the partitioning method,

FIGS. 5a and 5b are diagrams of matrix partitioning for parallel processing, and

FIG. 6 is a flowchart of the parallel circuit simulation method.

### DESCRIPTION OF SPECIFIC EMBODIMENTS

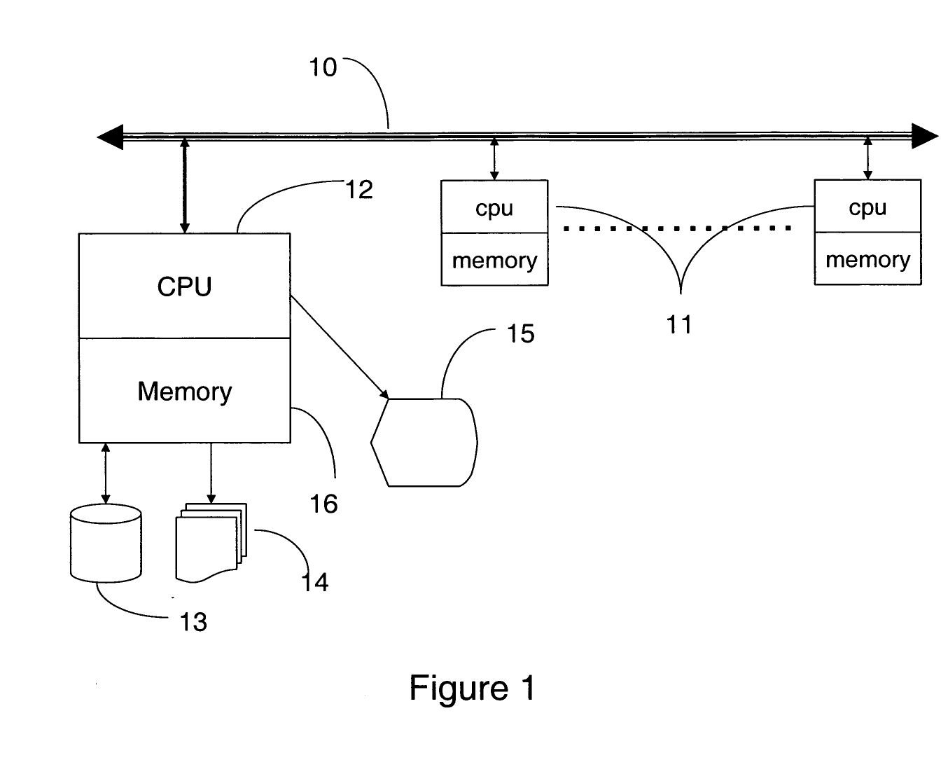

Reference is now made to FIG. 1, a diagram of a system of multiple processors with master and slave processors. While other multiprocessor systems may be utilized to perform parallel multi-processor circuit simulation, a configuration composed of a high speed bus 10, connected to a number of slave processors 11, and a single master processor 12, where each of the slave processors contains only the resources needed to perform the parallel simulation, while the master processor contains sufficient disk 13, printer 14, terminal 15, and memory 16 resources for inputting, translating, partitioning for parallel execution and outputting the results of the whole circuit system simulation, is more efficient.

In one embodiment of the present invention, the partitioning for parallel execution may be tuned to fit the limitations of both the number of slave processors and the resources, which reside with each processor.

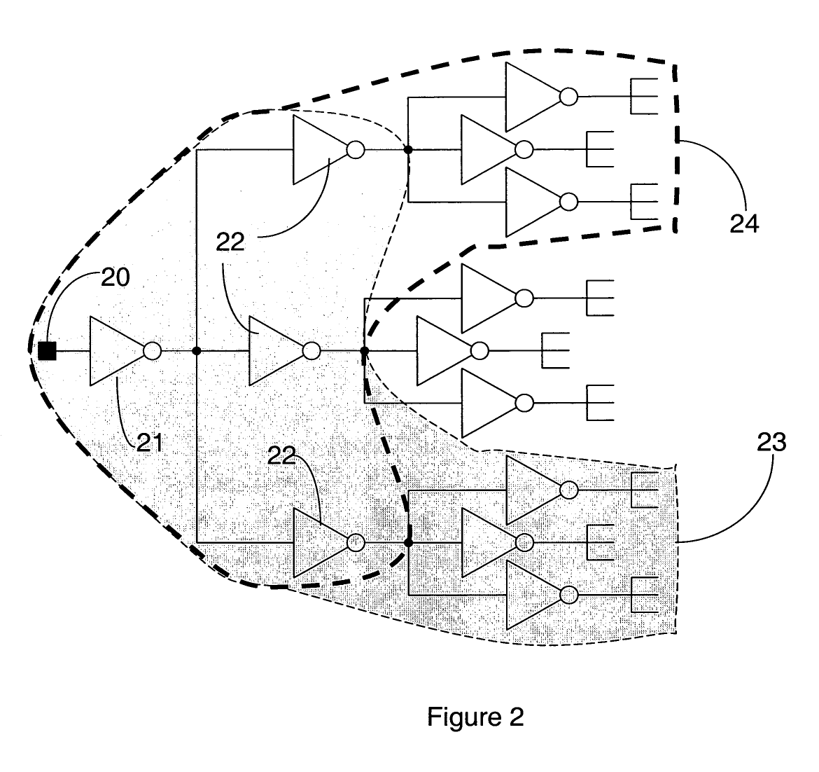

Reference is now made to FIG. 2, a diagram of a partitioned clock tree structure. Typically a clock tree consists of a root 20, connected to an initial inverter 21, which drives one or more second stage inverters 22, each of which in turn recursively drives multiple stages of inverters like the second stage. This fan-out tree continues until the leaves drive individual or groups of storage elements in the design. Because the errors related to simulating signals propagating through such a structure are minimal when including all loads associated with each net being simulated, the entire structure may be broken into multiple branches, each branch containing the root 20, the initial inverter 21, the second stage inverters 22, and a branch of the tree driven by one of the second stage inverters. Two such partitions are shown in dotted lines 23 and 24, each of which contains a duplicate copy of the root 20, the initial inverter 21 and the second stage inverters 22.

In another embodiment of the present invention, clock structures may be partitioned along branches of their tree structure duplicating the root and sufficient portions of the rest of the tree such that each branch may be separately simulated in parallel with all the other branches.

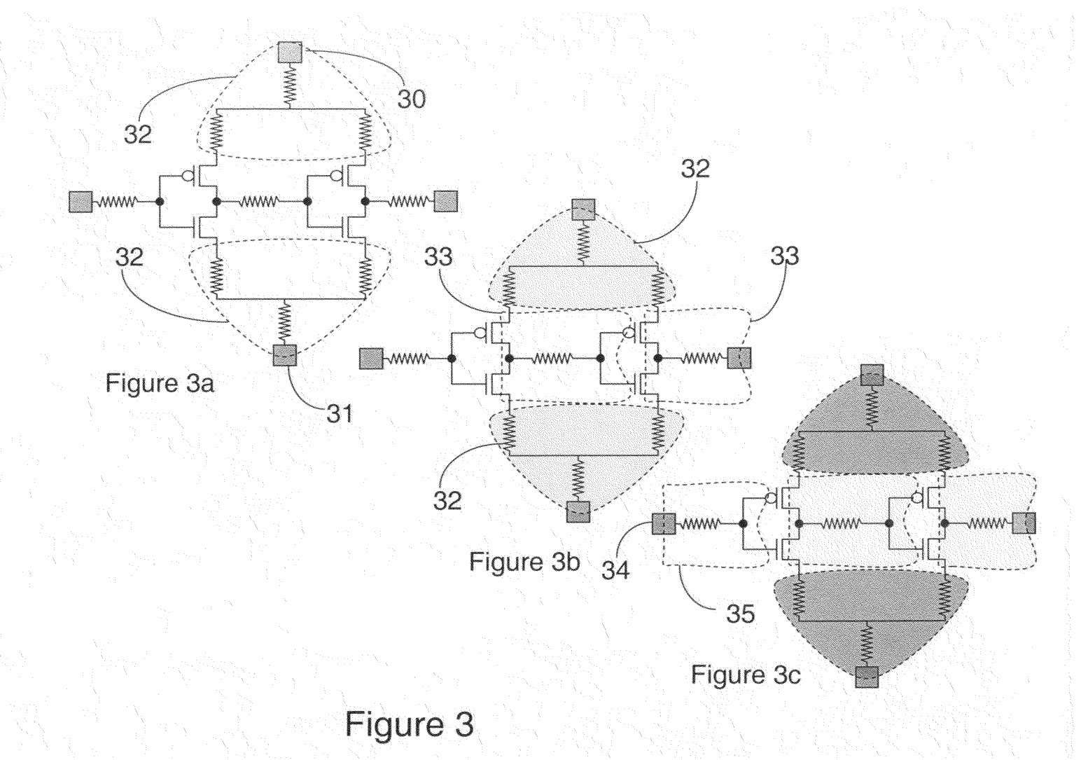

Reference is now made to FIG. 3, consisting of FIGS. 3a, 3b and 3c, which diagrammatically depict a method to partition the circuit level logic in to sub-circuits which may either be translated into SPD matrices or well behaved non-SPD matrices. In FIG. 3a, the passive resistor structure connected to the power root 30 and ground root 31 are traced into two sub-circuits 32. In FIG. 3b the outputs of the original two clusters 32 are traced into two other clusters 33, and in FIG. 3c, the primary inputs 34 are traced to obtain the last sub-circuit 35.

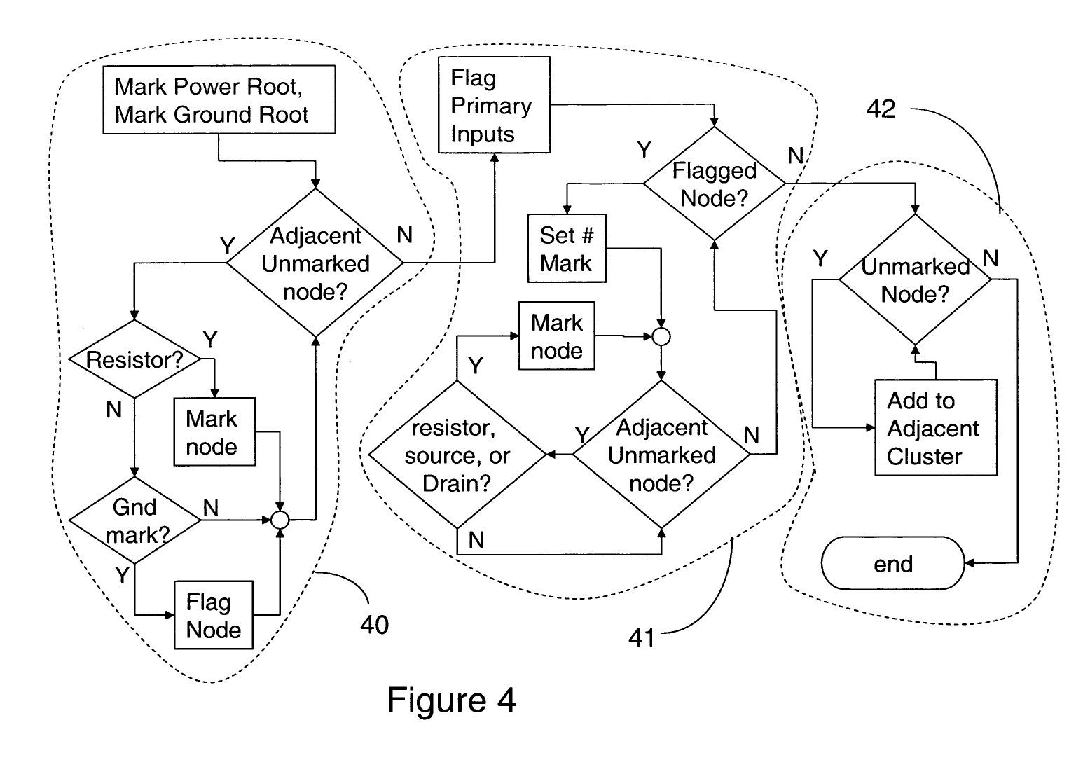

Reference is now made to FIG. 4, a flowchart of the partitioning method. There are three sections of the partitioning method. In the first section 40, propagates power and ground marks through the passive power and ground distribution network, defining two linear sub-circuits comprised of resistors. The second section 41 propagates marks for unique sub-circuits defined by the end points of the ground sub-circuit and the primary inputs to the circuit system. The last section 42 lumps any unmarked (floating) devices to an adjacent cluster. In this manner, each sub-circuit is guaranteed a ground path to discharge any voltage, thus ensuring reasonable stability when solving the resulting matrices generated for these sub-circuits.

Following the generation of the sub-circuits, the connectors between each sub-circuit are appended with a voltage/current regulator circuit for iteratively applying the intermediate results to and from the adjacent sub-circuits.

In yet another embodiment of the present invention a method for partitioning the circuit system into sub-circuits, which are either composed entirely of passive elements or are compose of elements with clear paths to power and ground, for the purpose of creating well behaved matrix models to be used in parallel circuit simulation, where the entire system may be partitioned into groups of one or more sub-circuits, such that each group may be simulated in parallel to all other groups.

It should be noted here, that the grouping of sub-circuits may be chosen to both minimize inter-processor communication and overall processing time, when performing the parallel simulation, and should be chosen to best fit the configuration and resources of the slave processors. Furthermore, some resulting sub-circuits, such as the power and ground structures, may be coupled with other timing critical sub-circuits, such as the branches of a clock tree, as described above. Such combinations ensure proper treatment of the self induced power and ground noise when modeling the resulting sub-circuit.

Even after such sub-circuit partitioning as described above is performed one or more of the resulting matrices created for the sub-circuits may be sufficiently large enough to require further partitioning. It such cases it may be necessary to further partition the matrices themselves.

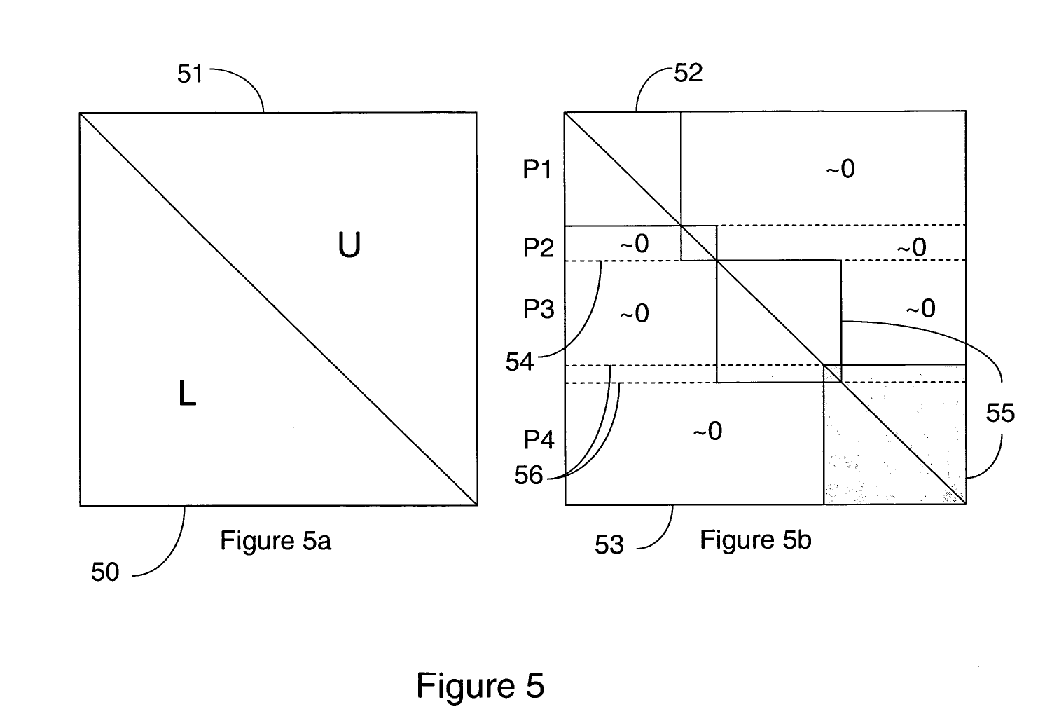

Reference is now made to FIG. 5. diagrams of matrix partitioning for parallel processing. It is well known in applied mathematics that matrices which are symmetric positive definite in structure may be decomposed into lower 50 and upper 51 triangular parts as shown in FIG. 5a. Furthermore only the lower triangular matrix, which contains positive diagonal elements, is needed for matrix inversion. The passive networks produce these types of matrices, which are well suited, if small enough, for LU decomposition techniques. In other cases where the networks are non-linear and don't necessarily produce SPD matrices. In either case, if the network, and associated matrix is large, it may be broken into blocks of rows such that each block may be processed separately. The equations for large systems of circuits typically form sparse matrices, where most of the entries in the matrices have zero or near zero values. To minimize the communication between the processors, when parallel processing partitions, each consisting of some of the rows of the original matrix, it is necessary to first reorder the matrix such that the few large values are closest to the diagonal, such as shown in FIG. 5b. This reordering creates sub-matrices consisting of large non-zero values 52 and sub-matrices 53 consisting of zero or near zero values, off the diagonal. One such method employs block triangular factorization in order to reduce the sizes of the non-zero sub-matrices, followed by an approximate minimal ordering (AMD) technique to reduce the complexity of each sub-matrix. Such methods would produce matrices as shown in FIG. 5b. Now the boundaries 54 between the partitions of rows may be chosen by finding the rows where sub-matrices with near-zero elements are closest to the diagonal. In some cases the sub-matrices 55 may overlap. In such cases, two rows 56, one determined by the near-zero elements closest to the diagonal of the upper triangular matrix and one determined by the near-zero elements closest to the diagonal of the lower triangular matrix may be found. The resulting rows between these two boundaries may then be duplicated and place in both upper and lower groups of rows. As a result, the communication between each group of rows is minimized, allowing for more efficient parallel execution of the chosen matrix solver.

So, in yet another embodiment of the present invention, sparse matrix reordering techniques may be employed to organize the matrices for row partitioning to minimize the inter-processor communication needed while processing each of the row partitions.

A number of LU decomposition matrix solvers exist including KLU, Cholesky decomposition, and Block Triangular. They all advantageously perform direct inversions of the matrix being solved, but are generally limited in how large a sub-circuit they can handle and require positive definite matrices in order to find a solution. The sub-circuits composed of passive elements convert into SPD matrices and as such are good candidates for decomposition solvers, if they are small enough to be processed. On the other hand, iterative solvers such as GmRes and AMG that can handle larger matrices, are not limited to SPD matrices, but do not always converge rapidly on a solution, particularly if the solution is a large incremental step from the current state of the simulation. Furthermore, both types of matrix solvers may be implemented in either serial or parallel form, with varying degrees of resulting improvement in execution time.

When using the techniques previously described in this disclosure, the sub-circuits and blocks of rows may vary in size. As such when choosing a method, the type of matrix, the size of the row blocks and the degree of transient changes in input voltage must all be taken into consideration. For example while LU decomposition is more appropriate for linear networks, and DC analysis, the power and ground sub-circuits are typically too large for such methods and therefore must be solved with GmRes or AMG techniques. On the other hand, it may be appropriate to use a decomposition technique as a precursor to an iterative technique when the transients are large, since the iterative solvers converge more rapidly when they are close to the actual solution.

In yet another embodiment of the present invention, the selection of a particular solver from parallel, serial, direct decomposition and iterative solvers, may vary both with the type of sub-circuit and with the type of simulation stimulus.

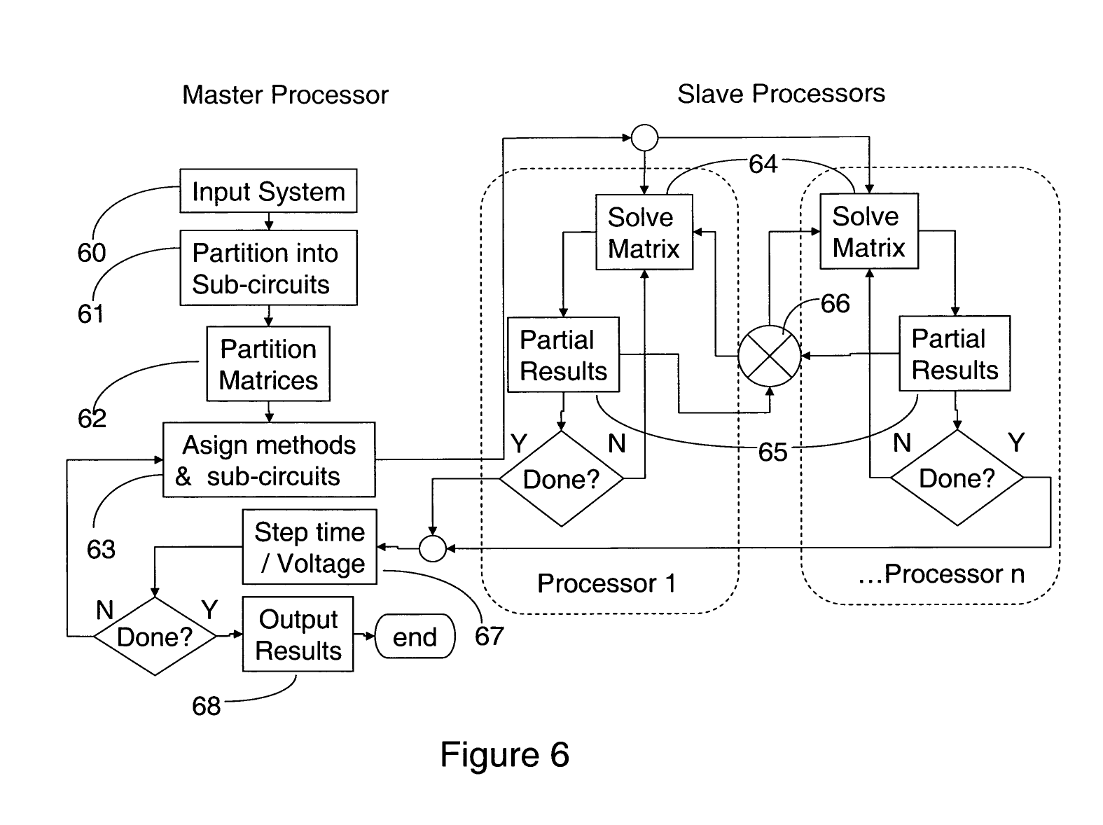

Reference is now made to FIG. 6, a flowchart of the parallel circuit simulation process. The network and simulation inputs are inputted 60 into the Master processor, at which time the network of circuits is partitioned onto sub-circuits 61 using the techniques previously disclosed. The sub-circuits are then converted into matrices, which are partitioned 62 into blocks of rows where appropriate. The sub-circuits and matrix solver methods are then assigned to the slave processors 63. Thereafter, each of the slave processors solves the partial or complete matrices 64 using the method or methods assigned to it. Partial results 65 are transmitted 66 to the other processors. This process continues until all processors have solved their matrices. This iterative process may involve partitions consisting of blocks of rows of a single matrix, which are processed in parallel across a number of processors, or parallel processing of multiple complete sub-circuits, where each sub-circuit is being processed by a single slave processor. In the former case, the intermediate terms are transmitted between the processors until a solution is reached, and then in both cases, on each iteration of the first stage of a modified two stage Newton-Raphson's iteration, the intermediate voltage/current changes are transmitted between processors, which are processing connected sub-circuits, until all the intermediate voltage/current changes reach stability. When the network of sub-circuits is stable, the results are passed back to the Master Processor, which sets the next time step 67 as part of the second stage of a modified two stage Newton-Raphson's iteration, and repeats the process until the simulation is complete, after which the results are outputted 68.

So, in yet another embodiment of the present invention, multiple parallel slave processes are spawned from a master process to solve both portions of the network of circuits and portions of the matrices created to solve other portions of the network of circuits, which separately communicate their intermediate partial results to the other slave processes until voltage/current stability in the entire network is reached.

Still, stability between the partitioned sub-circuits may require a large number of first stage iterations, when dealing with large sub-circuits and/or large voltage/current changes on the sub-circuit interfaces. In general an iterative solver such as AMG or GmRes works well then the initial conditions are near its final state, but may not converge if the voltage/current steps are too large. Such is the case at the initial DC condition, or when high frequency transients are simulated. In these cases, as a variant of the two-stage Newton-Raphson's method, before the next time iteration is invoked, the large voltage current steps are broken into multiple smaller incremental steps, which are successively applied to the portions of the network that are using iterative solvers.

Therefore, in yet another embodiment of the present invention, a modified two stage Newton-Raphson's method is employed to perform circuit simulation, where the method includes a first stage of iterating through the multiple components of the network until voltage/current stability is reached and then in a second stage iterates through increments of time to complete the simulation, but may include an intermediate step between the first and second stage to increment through large voltage/current steps for portions of the network which may otherwise be unstable.

It is contemplated that the techniques in the embodiments described herein are not limited to any specific matrix inversion technique. Furthermore, the above techniques may be used in part or in whole depending on the configuration IC system they are applied to. It is further contemplated that one or all of the techniques described herein may be applied to a wide variety of systems of computers and IC structures when suitably modified by one well versed in the state of the art.

We claim:

1. A method for simulating a system of circuits on a multiprocessor system, said multi-processor system consisting of:
A master processor containing sufficient storage and I/O to preprocess and postprocess the circuit model,
A plurality of slave processors, each with known storage and processing resources, and
A high speed bus connecting said master processor and said plurality of slave processors;
Said method including the steps of:
a) Inputting, translating and partitioning a model of said system of circuits on said master processor,
b) Transferring the partitions of said model of said system of circuits to said plurality of slave processors,
c) Executing said partitions on said plurality of slave processors, and
d) Collecting and outputting the results of said simulation on said master processor,
Wherein said partitioning is tuned to fit said known resources of said each of said plurality of said slave processors.

2. A method for simulating a system of circuits comprising the steps of:
a. Inputting, translating a model of said system of circuits
b. Partitioning said model of said system of circuits into a plurality of sub-circuit partitions, and row partitions,
c. Processing said sub-circuit partitions and said row partitions, and
d. Outputting the results of said simulation.

3. A method as in claim 2, wherein said processing is performed on a plurality of processors in parallel.

4. A method as in claim 3 where in said sub-circuit partitions are created to minimize communication between said plurality of processors.

5. A method as in claim 2 wherein said partitions include; at least one sub-circuit composed of passive elements, and at least one sub-circuit composed of elements with clear paths to power and ground.

6. A method as in claim 2, wherein
said system of circuits includes at least one clock tree structure,
said partitioning includes partitioning said at least one clock tree structure into a plurality of partitions each containing at least one clock branch, and
said processing said sub-circuit partitions includes simulating at least two of said partitions each containing at least one clock branch on at least two processors in parallel.

7. A method as in claim 6, wherein at least one of said partitions each containing at least one clock branch also includes at least one sub-circuit composed of passive elements.

8. A method as in claim 2 wherein step (b) includes partitioning the matrix of at least one said sub-circuit partition into a plurality of row partitions, and step (c) include processing said plurality of row partitions.

9. A method as in claim 8 wherein said processing of said plurality of row partitions includes distributing said plurality of row partitions to a plurality of processors, and processing said plurality of row partitions in parallel.

10. A method as in claim 9 wherein said row partitions are created to minimize communication between said plurality of processors.

11. A method as in claim 8 wherein said partitioning the matrix of at least one sub-circuit partition includes the steps of:
a. Reordering the rows of the matrix associated with said at least one said sub-circuit partition to bring the largest values closest to the diagonal of said matrix,
b. Selecting boundary rows where sub-matrices with near zero elements are closest to the diagonal of said matrix, and
c. Partitioning said matrix at said boundary rows into said plurality of row partitions, wherein each of said row partitions consists of at least one row of said reordered matrix.

12. A method as in claim 11 wherein step at least one row of said reordered matrix is partitioned into at least two of said row partitions.

13. A method for simulating a system of circuits consisting of:
a. Inputting, translating and partitioning a model of said system of circuits into sub-circuit partitions,
b. Iteratively incrementing the simulation time and applying simulation stimulus to at least one of said sub-circuit partitions,
c. For each sub-circuit partition, selecting one of a plurality of serial, parallel and iterative solvers,
d. Solving said sub-circuit partition for said stimulus using the selected solver,
e. Repeating steps c and d until simulation is stable,
f. Repeating steps b, c, d, and e until all stimulus has been applied to said system of circuits, and
g. Collecting and outputting the results of said simulation;
Wherein said selecting is determined based on the type of said sub-circuit and the type of said stimulus.

14. A method as in claim 13 wherein step (a) includes partitioning the matrix of at least one said sub-circuit partition into a plurality of row partitions, step (c) include for each row partition selecting one of a plurality of serial, parallel and iterative solvers, and step (d) includes solving said row partition of said stimulus using the selected solver.

15. A method as in claim 13 wherein step (b) includes dividing said simulation time and said simulation stimulus into a plurality of smaller time increments and stimulus increments, wherein the number of said plurality of smaller time increments is a function of the size of said simulation stimulus and the number previous iterations of step e.
